(19) United States
(12) Patent Application Publication
(10) Pub. No.: US 2025/0069196 A1
(43) Pub. Date: Feb. 27, 2025

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: YOSUKE TAKADA, Kanagawa (JP)

(21) Appl. No.: 18/794,076

(22) Filed: Aug. 5, 2024

(30) Foreign Application Priority Data
Aug. 24, 2023 (JP) 2023-136527

(51) Int. Cl. G06T 5/60; G06T 5/70; H04N 23/71; H04N 23/72; H04N 23/73; H04N 23/76

(52) U.S. Cl. CPC G06T 5/60; G06T 5/70; H04N 23/71; H04N 23/72; H04N 23/73; H04N 23/76; G06T 2207/10024; G06T 2207/20081; G06T 2207/20084; G06T 2207/30168

(57) ABSTRACT

An image processing apparatus includes an estimation unit configured to estimate a noise amount of an input image and a fluctuation amount of luminance of the input image caused by noise or developing, and a restoration unit configured to reverse degradation of the input image based on the noise amount and the fluctuation amount.

### BACKGROUND OF THE INVENTION

### Cross-Reference to Priority Application

This application claims the benefit of Japanese Patent Application No. 2023-136527, filed Aug. 24, 2023, which is hereby incorporated by reference herein in its entirety.

### Field of the Invention

The present invention relates to a technique for reversing degradation of an image.

### Description of the Related Art

As a mechanism for realizing different improvements in sensitivity of an image sensor, there is a method of applying an analog gain and a digital gain to an image signal outputted from the image sensor. In general, it is known that applying these gains tends to increase the effects of noise.

In particular, in the dark portions of RAW images captured with high-sensitivity, a phenomenon called “fading of a black color”, in which what should be black becomes brighter and appears closer to gray due to noise, and a phenomenon called “darkening of a white color”, in which what should be white becomes darker, occur. Further, when an RGB image is generated by developing processing being performed on a RAW image in which fading of a black color has occurred, R and B components become relatively larger than a G component due to white balance correction, resulting in a loss of RGB color balance, and a phenomenon called a “magenta cast” in which colors change occurs. The extent of fading of a black color, darkening of a white color, and magenta cast fluctuates due to a difference in the amount of noise caused by an individual difference and a change in temperature of an image sensor.

Japanese Patent Laid-Open No. 2018-006785 discloses detecting pixels having a pixel value that is less than or equal to a preset threshold as black pixels for each frame before applying a digital gain. Further, Japanese Patent Laid-Open No. 2018-006785 discloses a method of suppressing variation in the amount of fading of a black color by adjusting an offset based on the number of black pixels of the current frame and the number of black pixels of the previous frame. Further, Japanese Patent Laid-Open No. 2021-114180 discloses a method of using deep learning (DNN) to reduce noise while suppressing a change in color of an image.

However, although the method disclosed in Japanese Patent Laid-Open No. 2018-006785 is robust to a change in temperature of the same sensor, it has difficulty in covering individual differences between sensors. Therefore, in the method disclosed in Japanese Patent Laid-Open No. 2018-006785, in a case where a DNN is used to reduce noise, there is a problem that it becomes specialized to the learned sensor.

Further, in the method disclosed in Japanese Patent Laid-Open No. 2021-114180, there is a problem that, for an image in which a magenta cast has already occurred, since noise is reduced with magenta being determined to be a color that should be there, the magenta cast remains.

### SUMMARY OF THE INVENTION

The present invention provides a technique for performing appropriate degradation reversal as reversal of degradation of an image even when defects such as fading of a black color, darkening of a white color, and a magenta cast occur.

According to the first aspect of the present invention, there is provided an image processing apparatus comprising: an estimation unit configured to estimate a noise amount of an input image and a fluctuation amount of luminance of the input image caused by noise or developing; and a restoration unit configured to reverse degradation of the input image based on the noise amount and the fluctuation amount.

According to the second aspect of the present invention, there is provided an image processing apparatus comprising: an estimation unit configured to estimate a noise amount of an input image captured by an imaging device and a fluctuation amount of luminance of the input image caused by noise or developing; and a control unit configured to control exposure of the imaging device based on the noise amount and the fluctuation amount.

According to the third aspect of the present invention, there is provided an image processing method to be performed by an image processing apparatus, the method comprising: estimating a noise amount of an input image and a fluctuation amount of luminance of the input image caused by noise or developing; and reversing degradation of the input image based on the noise amount and the fluctuation amount.

According to the fourth aspect of the present invention, there is provided an image processing method to be performed by an image processing apparatus, the method comprising: estimating a noise amount of an input image captured by an imaging device and a fluctuation amount of luminance of the input image caused by noise or developing; and controlling exposure of the imaging device based on the noise amount and the fluctuation amount.

According to the fifth aspect of the present invention, there is provided a non-transitory computer-readable storage medium storing a computer program for causing a computer to function as: an estimation unit configured to estimate a noise amount of an input image and a fluctuation amount of luminance of the input image caused by noise or developing; and a restoration unit configured to reverse degradation of the input image based on the noise amount and the fluctuation amount.

According to the sixth aspect of the present invention, there is provided a non-transitory computer-readable storage medium storing a computer program for causing a computer to function as: an estimation unit configured to estimate a noise amount of an input image captured by an imaging device and a fluctuation amount of luminance of the input image caused by noise or developing; and a control unit configured to control exposure of the imaging device based on the noise amount and the fluctuation amount.

Further features of the present invention will become apparent from the following description of exemplary embodiments with reference to the attached drawings.

### BRIEF DESCRIPTION OF THE DRAWINGS

FIG. 1 is a block diagram illustrating an example of a hardware configuration of an image processing system.

FIG. 2 is a block diagram illustrating an example of a functional configuration of the image processing system.

FIGS. 3A and 3B are diagrams illustrating a flow of inference and training.

FIG. 4A is a diagram illustrating a structure of a CNN and a flow of training.

FIG. 4B is a diagram illustrating a structure of a CNN and a flow of training.

FIG. 5A is a diagram illustrating a cause of occurrence of fading of a black color, darkening of a white color, and a magenta cast.

FIG. 5B is a diagram illustrating a cause of occurrence of fading of a black color, darkening of a white color, and a magenta cast.

FIG. 5C is a diagram illustrating a cause of occurrence of fading of a black color, darkening of a white color, and a magenta cast.

FIG. 5D is a diagram illustrating a cause of occurrence of fading of a black color, darkening of a white color, and a magenta cast.

FIG. 5E is a diagram illustrating a cause of occurrence of fading of a black color, darkening of a white color, and a magenta cast.

FIG. 6 is a diagram illustrating a process of imparting degradation.

FIG. 7A is a flowchart of various kinds of processing performed in the image processing system.

FIG. 7B is a flowchart of various kinds of processing performed in the image processing system.

FIG. 8 is a block diagram illustrating an example of a functional configuration of the image processing system.

FIG. 9A is a flowchart of various kinds of processing performed in the image processing system.

FIG. 9B is a flowchart of various kinds of processing performed in the image processing system.

FIG. 10 is a block diagram illustrating an example of a functional configuration of the image processing system.

FIG. 11A is a diagram illustrating suppression of a magenta cast.

FIG. 11B is a diagram illustrating suppression of a magenta cast.

FIG. 11C is a diagram illustrating suppression of a magenta cast.

FIG. 12A is a flowchart of various kinds of processing performed in the image processing system.

FIG. 12B is a flowchart of various kinds of processing performed in the image processing system.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <CNN>

First, a convolutional neural network (CNN), which is used in each of the following embodiments and is used in all information processing techniques in which deep learning is applied, will be described. A CNN is a technique in which convolution of a filter generated by training (or learning) across an image followed by a nonlinear operation is repeated. A filter is also referred to as a local receptive field. An image obtained by performing a nonlinear operation after a filter has been convolved across an image is called a feature map. Further, training is performed using training data (training images or data sets) constituted by pairs of an input image and an output image. Simply put, training is to generate, from training data, the values of a filter that can convert an input image to a corresponding output image with high accuracy. Details thereof will be described later.

If an image has RGB color channels or if a feature map is constituted by a plurality of images, a filter used for convolution also will have a plurality of channels accordingly. That is, convolution filters are expressed by a four-dimensional array to which, in addition to a vertical and horizontal size and the number of filters, the number of channels has been added. Processing for convolving a filter across an image (or feature map) and then performing a nonlinear operation is expressed in units of layers, and for example, expressions such as an n-th layer feature map and an n-th layer filter are used. For example, a CNN that repeats convolution of a filter and a nonlinear operation three times has a three-layer network structure. Such nonlinear operation processing can be formulated as in the following Equation (1).

$$\begin{matrix}[ EQUATION 1 ] & \\ {X}_{n}^{( l )} = f ( {\sum }_{k = 1}^{K} {W}_{n}^{( l )} * {X}_{n - 1}^{( l )} + {b}_{n}^{( l )} ) & ( 1 )\end{matrix}$$

In the above Equation (1), Wn indicates an n-th layer filter, bn indicates an n-th layer bias, f indicates a nonlinear operator, Xn indicates an n-th layer feature map, and * indicates a convolution operator. A superscript (l) of each variable indicates that it is an l-th filter or feature map. k indicates an identifier of a neuron in the same layer, and K indicates the total number of neurons in the same layer. Filters and biases are generated by training, which will be described later, and are also collectively referred to as “network parameters”. As a nonlinear operation, sigmoid function or Rectified Linear Unit (ReLU), for example, is used. ReLu is given by the following Equation (2).

$$\begin{matrix}[ EQUATION 2 ] & \\ f ( X ) = \{ \begin{matrix}X if 0 \leq X \\ 0 otherwise\end{matrix} & ( 2 )\end{matrix}$$

As indicated in the above Equation (2), among the elements of an inputted vector X, negative elements become zero and positive elements remain as is. As networks in which a CNN is used, ResNet of an image recognition field and its application in a super-resolution field, SRCNN, are well known. In both cases, by configuring a CNN to be multi-layered and performing convolution of a filter many times, improvement in accuracy of processing is achieved. For example, ResNet is characterized by a network structure in which a path for shortcutting convolutional layers is provided and thereby realizes a multi-layer network with as many as 152 layers and realizes high-accuracy recognition approaching human recognition rates. Simply put, the reason why processing improves in accuracy due to a multi-layer CNN is that by repeating a nonlinear operation many times, it is possible to express a nonlinear relationship between input and output.

### <Training of CNN>

Next, training of a CNN will be described. A CNN is generally trained by minimizing an objective function expressed by the following Equation (3) for training data constituted by pairs of an input training image (student image) and an output training image (teacher image) corresponding to the input training image.

$$\begin{matrix}[ EQUATION 3 ] & \\ L ( θ ) = \frac{1}{n} {\sum }_{i = 1}^{n} {‖ F ( {X}_{i} ; θ ) - {Y}_{i} ‖}^{2} & ( 3 )\end{matrix}$$

In the above Equation (3), L indicates a loss function, which measures an error between a ground truth and an estimation thereof. Further, Yi indicates an i-th output training image and Xi indicates an i-th input training image. Further, F indicates a function collectively indicating Equation (1), which is an operation performed in each layer of the CNN. Further, θ indicates network parameters (filters and biases). Further, ∥Z∥₂ is an L2 norm and, simply put, indicates a square root of the sum of squares of the elements of a vector Z. Further, n indicates the total number of pieces of training data to be used for training. Since the total number of pieces of training data is generally large, in stochastic gradient descent (SGD), a part of the training data is randomly selected and used for training. This makes it possible to reduce computational load in training in which a large amount of training data is used. Further, various methods such as a momentum method, an AdaGrad method, an AdaDelta method, and an Adam method are known as a method of minimizing (optimizing) the objective function. The Adam method is given by the following Equations (4).

$$\begin{matrix}[ EQUATION 4 ] & \\ g = \frac{\partial L}{\partial {θ}_{i}^{t}} & ( 4 )\end{matrix}$$

$$m = {β}_{1} m + ( 1 - {β}_{1} ) g$$

$$v = {β}_{2} v + ( 1 - {β}_{2} ) {g}^{2}$$

$${θ}_{i}^{t + l} = {θ}_{i}^{t} - α \frac{\sqrt{1 - {β}_{2}^{t}}}{( 1 - {β}_{1} )} \frac{m}{( \sqrt{v} + ∈ ε )}$$

In the above Equations (4), θᵢ^{t} is an i-th network parameter in a t-th iteration, and g is a gradient of the loss function L related to θᵢ^{t}. Further, m and v are moment vectors, α is a base learning rate, β1 and β2 are hyperparameters, and ε is a small constant. Since there is no guideline for selecting an optimization method in training, in general anything may be used, but it is known that, since there is a difference in convergence for each method, there is a difference in training time.

In the present embodiment, it is assumed that information processing (image processing) for reducing degradation of an image is performed using the CNN described above. As degradation factors of an image, there are fading of a black color, darkening of a white color, and a magenta cast caused by noise. Image degradation reversal processing in the present embodiment is processing for generating or recovering an image without (or with very little) degradation from an image with degradation and is referred to as image restoration processing in the following description.

### First Embodiment

In the present embodiment, a method of independently estimating each of a noise amount of an input image and the amount of magenta cast and the amount of darkening of a white color caused by noise and reversing degradation of the input image based on respective estimation results will be described.

### <Example of Configuration of Image Processing System>

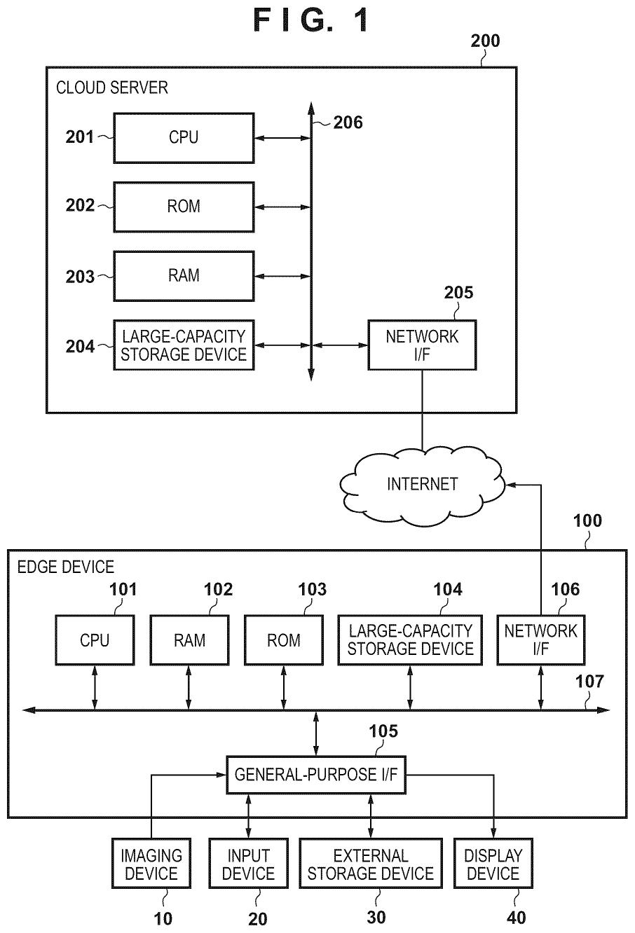

First, an example of a hardware configuration of an image processing system according to the present embodiment will be described with reference to a block diagram of FIG. 1. As illustrated in FIG. 1, the image processing system according to the present embodiment includes a cloud server 200 and an edge device 100, and the cloud server 200 and the edge device 100 are configured so as to be capable of data communication with each other via the Internet. In the image processing system according to the present embodiment, the cloud server 200 is responsible for generating training data and training (hereinafter, referred to as degradation reversal training) a CNN for reversing degradation of image quality, and the edge device 100 is responsible for reversing (hereinafter, degradation reversal inference) image degradation.

A network configuration between the cloud server 200 and the edge device 100 is not limited to a specific network configuration. For example, the cloud server 200 and the edge device 100 may be connected by a LAN, or the cloud server 200 and the edge device 100 may be connected via two or more types of networks. The networks may be wireless, wired, or a combination thereof.

### <Example of Hardware Configuration of Edge Device>

The edge device 100 of the present embodiment, obtains an RGB image directly or indirectly inputted from an imaging device 10 as an input image to be a target of image restoration processing. Then, the edge device 100 performs degradation reversal inference by applying a trained model provided from the cloud server 200 to the input image. That is, the edge device 100 is an image processing apparatus that uses a trained model provided from the cloud server 200 and executes an information processing application program installed in advance on the edge device 100 to reduce noise in an RGB image.

A CPU 101 executes various kinds of processing using computer programs and data stored in a RAM 102. By this, the CPU 101 performs control of operation of the entire edge device 100 and executes or controls various kinds of processing to be described as processing to be performed by the edge device 100.

The RAM 102 includes an area for storing computer programs and data loaded from a ROM 103, a large-capacity storage device 104, and an external storage device 30. Further, the RAM 102 includes an area for storing, for example, a trained model received from the cloud server 200 via a network I/F 106, and an area for storing an input image outputted from the imaging device 10. Further, the RAM 102 includes a work area to be used for when the CPU 101 performs various kinds of processing. As described above, the RAM 102 can provide various areas as appropriate.

The ROM 103 stores setting data of the edge device 100, computer programs and data for activating the edge device 100, computer programs and data for basic operations of the edge device 100, and the like.

The large-capacity storage device 104 is a large-capacity secondary storage device such as an HDD or an SSD. The large-capacity storage device 104 stores an operating system (OS), computer programs and data for causing the CPU 101 to execute or control various kinds of processing to be described as processing to be performed by the edge device 100, and the like. The computer programs stored in the large-capacity storage device 104 may also include the information processing application program described above. The computer programs and data stored in the large-capacity storage device 104 are loaded into the RAM 102 as appropriate according to control by the CPU 101 and are processed by the CPU 101.

The network I/F 106 is a communication interface for performing data communication with the cloud server 200 via the Internet. For example, the edge device 100 obtains a trained model for degradation reversal inference by accessing the cloud server 200 using a web browser installed in advance on the edge device 100.

A general-purpose I/F 105 is, for example, a serial bus interface such as USB, IEEE 1394, and HDMI®. The edge device 100 obtains computer programs and data from the external storage device 30 (e.g., various storage media such as a memory card, a CF card, an SD card, and a USB memory) via the general-purpose I/F 105. The edge device 100 receives user instructions and information from an input device 20 via the general-purpose I/F 105. The input device 20 is a user interface such as a keyboard, a mouse, and a touch panel screen and, by being operated by a user, can input various user instructions and information to the edge device 100. The edge device 100 outputs a result (such as images and text) of processing by the CPU 101 to a display device 40 via the general-purpose I/F 105. By this, the display device 40 can display a result of processing by the edge device 100 using images, text, and the like. The display device 40 may be a device including a liquid crystal screen or a touch panel screen or may be a projection device such as a projector for projecting images and text. The edge device 100 obtains an input image from the imaging device 10 via the general-purpose I/F 105.

The imaging device 10 may be an imaging device for capturing a moving image or may be an imaging device for periodically or irregularly capturing a still image. When the imaging device 10 is an imaging device for capturing a moving image, the imaging device 10 outputs an image of each frame in the moving image, and the edge device 100 obtains the image as an input image. Meanwhile, when the imaging device 10 is an imaging device for periodically or irregularly capturing a still image, the imaging device 10 outputs the still image, and the edge device 100 obtains the still image as an input image. The CPU 101, the RAM 102, the ROM 103, the large-capacity storage device 104, the network I/F 106, and the general-purpose I/F 105 are all connected to a system bus 107.

### <Example of Hardware Configuration of Cloud Server>

The cloud server 200 of the present embodiment is an image processing apparatus that provides a cloud service on the Internet. To be more specific, the cloud server 200 generates training data and performs degradation reversal training and thereby generates a trained model in which network parameters, which are a result of the degradation reversal training, are stored. Then, the cloud server 200 provides the trained model to the edge device 100 in response to a request from the edge device 100.

A CPU 201 executes various kinds of processing using computer programs and data stored in a RAM 203. By this, the CPU 201 performs control of operation of the entire cloud server 200 and executes or controls various kinds of processing to be described as processing to be performed by the cloud server 200.

The ROM 202 stores setting data of the cloud server 200, computer programs and data for activating the cloud server 200, computer programs and data for basic operations of the cloud server 200, and the like.

The RAM 203 includes an area for storing computer programs and data loaded from the ROM 202 and a large-capacity storage device 204 and a work area to be used when the CPU 201 executes various kinds of processing. Further, the RAM 203 includes an area for storing computer programs and data transmitted from the edge device 100 via a network I/F 205. As described above, the RAM 203 can provide various areas as appropriate.

The large-capacity storage device 204 is a large-capacity secondary storage device such as an HDD or an SSD. The large-capacity storage device 204 stores an operating system (OS), computer programs and data for causing the CPU 201 to execute or control various kinds of processing to be described as processing to be performed by the cloud server 200, and the like. The computer programs and data stored in the large-capacity storage device 204 are loaded into the RAM 203 as appropriate according to control by the CPU 201 and are processed by the CPU 201.

The network I/F 205 is a communication interface for performing data communication with the edge device 100 via the Internet. For example, the cloud server 200 provides a trained model to the edge device 100 in response to a request from a web browser operating on the edge device 100. The CPU 201, the ROM 202, the RAM 203, the large-capacity storage device 204, and the network I/F 205 are all connected to a system bus 206.

The hardware configuration of the edge device 100 illustrated in FIG. 1 is an example and can be appropriately modified or changed. Similarly, the hardware configuration of the cloud server 200 illustrated in FIG. 1 is an example and can be appropriately modified or changed.

For example, the cloud server 200 may be implemented by one computer device or two or more computer devices. When the cloud server 200 is implemented by two or more computer devices, training data may be generated by one computer device and degradation reversal training may be performed by another computer device.

In FIG. 1, the number of edge devices 100 connected to the cloud server 200 is assumed to be 1, but two or more edge devices 100 may be connected to the cloud server 200.

Further, for example, in FIG. 1, the imaging device 10 and the edge device 100 are assumed to be separate devices, but the imaging device 10 and the edge device 100 may be integrated to constitute one imaging device. In this case, the one imaging device includes, in addition to an imaging function, the functions of the edge device 100.

Further, for example, in FIG. 1, the cloud server 200 and the edge device 100 are assumed to be separate devices, but the cloud server 200 and the edge device 100 may be integrated to constitute one device. In this case, the one device can execute training data generation, degradation reversal training, and degradation reversal inference.

Further, for example, in FIG. 1, the cloud server 200, the edge device 100, and the imaging device 10 are assumed to be separate devices, but the cloud server 200, the edge device 100, and the imaging device 10 may be integrated to constitute one device. In this case, the one device can execute imaging, training data generation, degradation reversal training, and degradation reversal inference.

### <Example of Functional Configuration of Entire Image Processing System>

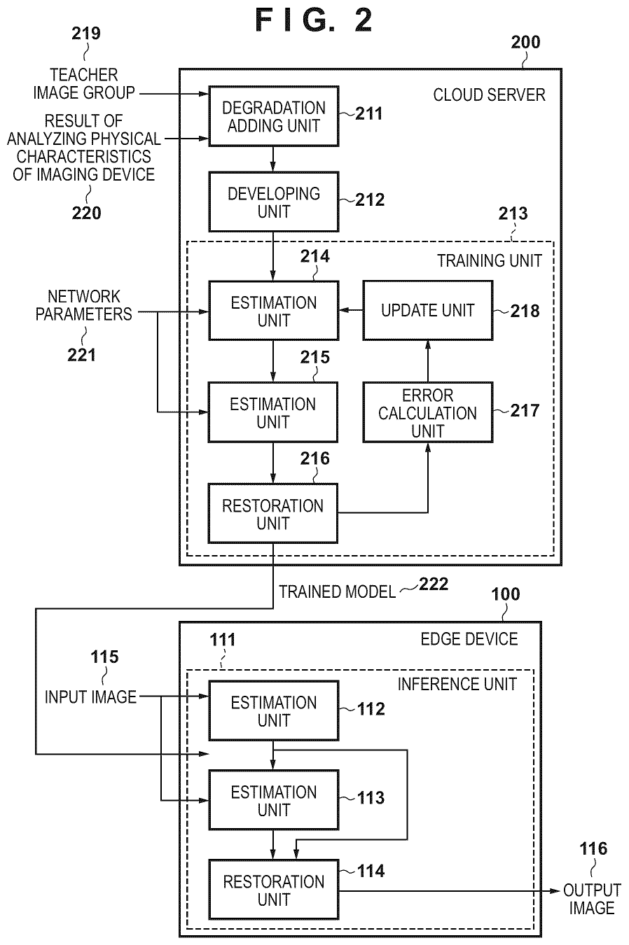

Next, an example of a functional configuration of the image processing system according to the present embodiment will be described with reference to a block diagram of FIG. 2. In the present embodiment, a case where the functional units of the cloud server 200 and the functional units of the edge device 100 illustrated in FIG. 2 are all implemented by computer programs will be described. Further, in the present embodiment, the functional units of the cloud server 200 and the functional units of the edge device 100 illustrated in FIG. 2 will be described as performers of processing. However, in practice, the functions of the functional units of the cloud server 200 are realized by the CPU 201 executing computer programs corresponding to the functional units. Similarly, the functions of the functional units of the edge device 100 are realized by the CPU 101 executing computer programs corresponding to the functional units. One or more of the functional units illustrated in FIG. 2 may be implemented by hardware. First, each functional unit of the edge device 100 will be described.

An inference unit 111 estimates a noise amount and a luminance fluctuation amount of an input image 115 obtained from the imaging device 10, using a trained model 222 obtained from the cloud server 200, and performs degradation reversal inference based on a result of the estimation. Here, in the present embodiment, an RGB image in which each pixel has RGB pixel values is used as the input image 115. Further, the trained model 222 is a CNN that has been trained to perform noise amount estimation, luminance fluctuation amount estimation, and degradation reversal inference.

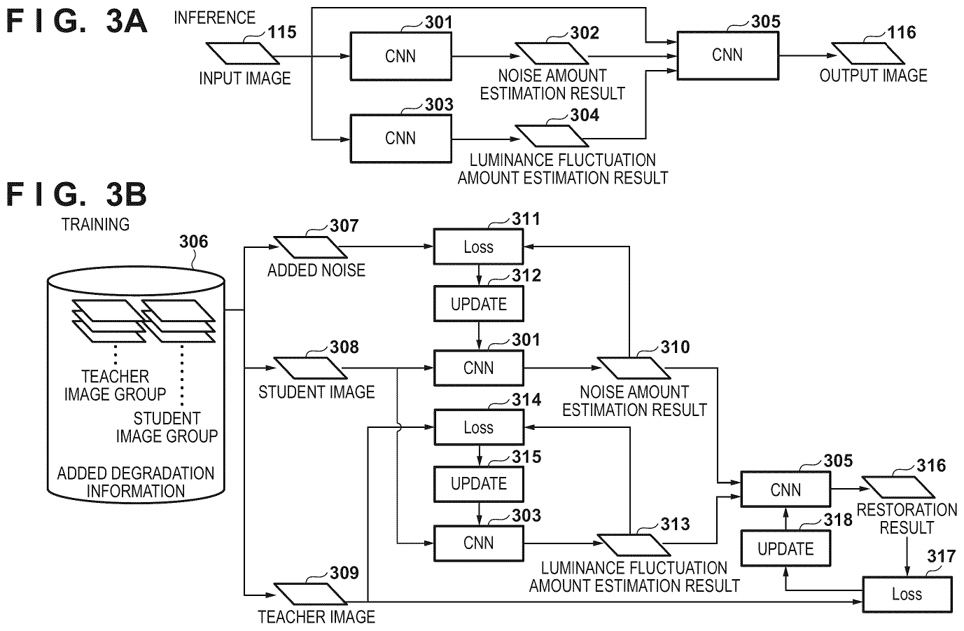

An estimation unit 112 estimates a noise amount of the input image 115 using the trained model 222. FIG. 3A is a diagram illustrating a flow of processing in the inference unit 111. The trained model 222 includes a CNN 301, a CNN 303, and a CNN 305. As illustrated in FIG. 3A, the estimation unit 112 inputs the input image 115 to the CNN 301 and, by performing computation of the CNN 301 by repeating a convolution operation according to a filter and a nonlinear operation which are expressed by Equations (1) and (2) a plurality of times, outputs a noise amount estimation result 302 which is a result of estimation of the noise amount of the input image 115.

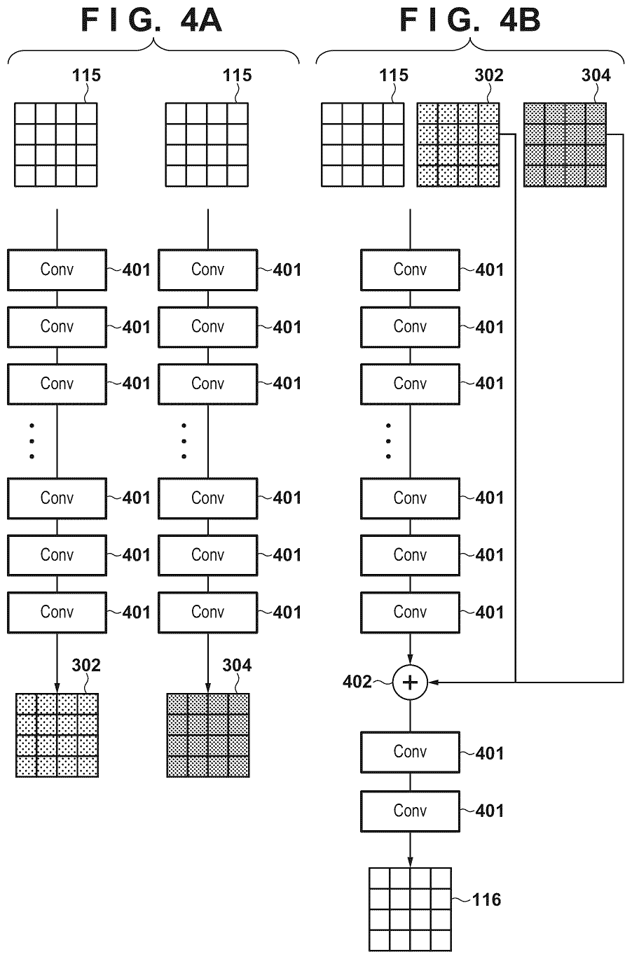

FIGS. 4A and 4B are diagrams illustrating structures of CNNs and flows of inference and training. First, processing of the CNN 301 will be described with reference to FIGS. 3A and 4A. The CNN 301 includes a plurality of filters 401 for performing an operation of Equation (1) described above. First, the estimation unit 112 inputs the input image 115 to the CNN 301 and, by sequentially applying the filters 401 across the input image 115, calculates a feature map (not illustrated). Then, the estimation unit 112 calculates a result of applying the last filter 401 as the noise amount estimation result 302. The noise amount estimation result 302 has the same channels as the input image 115.

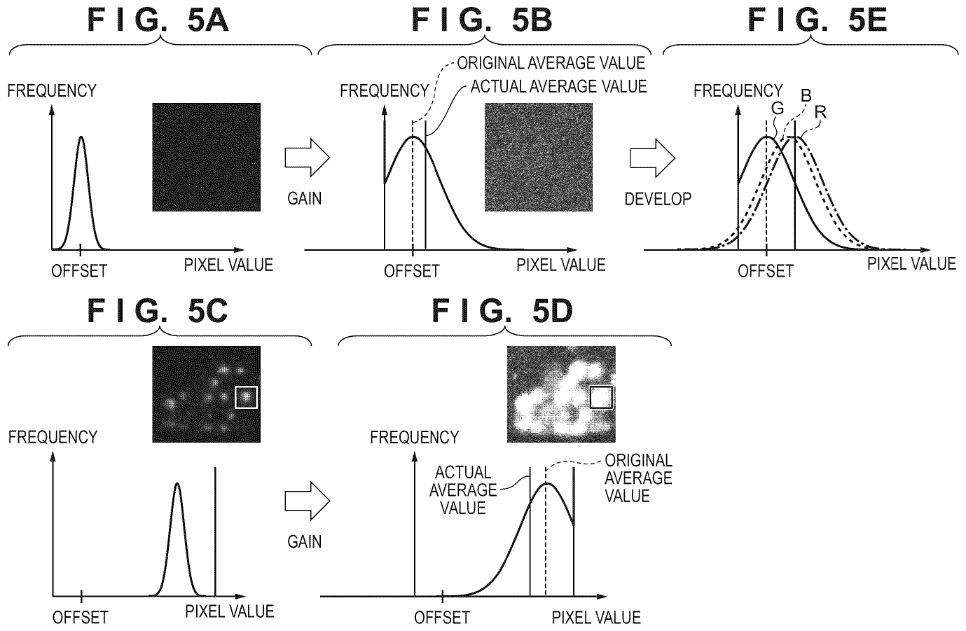

An estimation unit 113 estimates a luminance fluctuation amount of the input image 115 caused by fading of a black color, darkening of a white color, a magenta cast, and the like using the trained model 222. As illustrated in FIG. 3A, the estimation unit 113 inputs the input image 115 to the CNN 303 and, by performing computation of the CNN 303 by repeating a convolution operation according to a filter and a nonlinear operation which are expressed by Equations (1) and (2) a plurality of times, outputs a luminance fluctuation amount estimation result 304 which is a result of estimation of the luminance fluctuation amount of the input image 115. Processing of the CNN 303 will be described with reference to FIGS. 3A and 4A. The CNN 303 includes a plurality of filters 401 for performing an operation of Equation (1) described above. First, the estimation unit 113 inputs the input image 115 to the CNN 303 and, by sequentially applying the filters 401 across the input image 115, calculates a feature map (not illustrated). Then, the estimation unit 113 calculates a result of applying the last filter 401 as the luminance fluctuation amount estimation result 304. The luminance fluctuation amount estimation result 304 has the same channels as the input image 115. Here, fluctuation in luminance of the input image 115 is caused by fading of a black color, darkening of a white color, and a magenta cast. Hereinafter, causes of occurrence of fading of a black color, darkening of a white color, and a magenta cast will be described in order with reference to FIG. 5.

First, fading of a black color will be described. FIG. 5A illustrates a distribution of pixel values of an optical black region (OB region) when an image is captured in a condition in which a digital gain is not applied, and a rectangular image is an example of the OB region. The OB region is a region that is shielded from light by a metallic film or the like of an image sensor. The horizontal axis represents pixel value, and the vertical axis represents the frequency of each pixel value. Further, the distribution is such that it is concentrated around the offset due to dark current and readout noise.

FIG. 5B illustrates a distribution of pixel values in the OB region for when a digital gain is applied to the condition of FIG. 5A, and since, in practice, negative values cannot be held for hardware reasons, the negative values are clipped to 0. By this, an average value that was originally around the offset is shifted in a positive direction. As a result, “black” cannot be displayed correctly and, as illustrated in a rectangular image of FIG. 5B, appears brighter than the rectangular image of FIG. 5A. This is fading of a black color.

Next, darkening of a white color will be described. FIG. 5C illustrates a distribution of pixel values just before a maximum value that they may take, and a white region in a rectangular image is an example. FIG. 5D illustrates a distribution of pixel values for when a digital gain is applied to the condition of FIG. 5C, and since, in practice, values exceeding the maximum value cannot be held for hardware reasons, they are clipped to the maximum value. By this, an average value that was originally just before the maximum value is shifted in a negative direction. As a result, brightness becomes darker than what it originally was. This is darkening of a white color.

Finally, a magenta cast will be described. FIG. 5E illustrates a distribution of pixel values of the OB region for when developing processing is applied to the condition of FIG. 5B. R and B components become relatively larger than a G component due to white balance correction that is applied during developing, resulting in a loss of RGB color balance. This is a magenta cast.

The above is a detailed description of fading of a black color, darkening of a white color, and a magenta cast. The estimation unit 113 estimates the amount of fluctuation in luminance caused by these phenomena. A noise amount and a luminance fluctuation amount are in a proportional relationship, and for example, the amount of fluctuation in luminance caused by processing for fitting the noise amount within a range of unsigned integers that can be stored at a predetermined bit depth is estimated.

Although it is difficult to determine offset and white balance values from an input image, in general an offset is a value set in advance and white balance is a value calculated in the imaging device 10 at the time of imaging. Therefore, by obtaining in advance and utilizing these values, it is possible to improve the accuracy of estimation of a luminance fluctuation amount.

A restoration unit 114 obtains the noise amount (noise amount estimation result 302) of the input image 115 estimated by the estimation unit 112 and the luminance fluctuation amount (luminance fluctuation amount estimation result 304) of the input image 115 estimated by the estimation unit 113. Then, the restoration unit 114 performs processing for reversing degradation of the input image 115 based on the noise amount of the input image 115 (noise amount estimation result 302) and the luminance fluctuation amount (luminance fluctuation amount estimation result 304) of the input image 115. Specifically, as illustrated in FIG. 3A, the restoration unit 114 inputs the input image 115, the noise amount estimation result 302, and the luminance fluctuation amount estimation result 304 to the CNN 305. Then, by performing computation of the CNN 305 by repeating a convolution operation according to a filter and a nonlinear operation which are expressed by Equations (1) and (2) a plurality of times, the restoration unit 114 outputs an output image 116, which has been subjected to the restoration processing.

Next, processing of the CNN 305 will be described with reference to FIGS. 3A and 4B. The CNN 305 includes a plurality of filters 401 and a connected layer 402 as illustrated in FIG. 4B. First, the restoration unit 114 inputs the input image 115, the noise amount estimation result 302, and the luminance fluctuation amount estimation result 304 which have been concatenated or added along a channel dimension to the CNN 305 as input data. Next, the restoration unit 114 calculates a feature map by sequentially applying the filters 401 across the input data. Then, the restoration unit 114 concatenates the feature map and the input data along a channel dimension, using the connected layer 402. Further, the restoration unit 114 sequentially applies the filters 401 across a result of that concatenation and outputs the output image 116, which has the same number of channels as the input image 115, from the final filter.

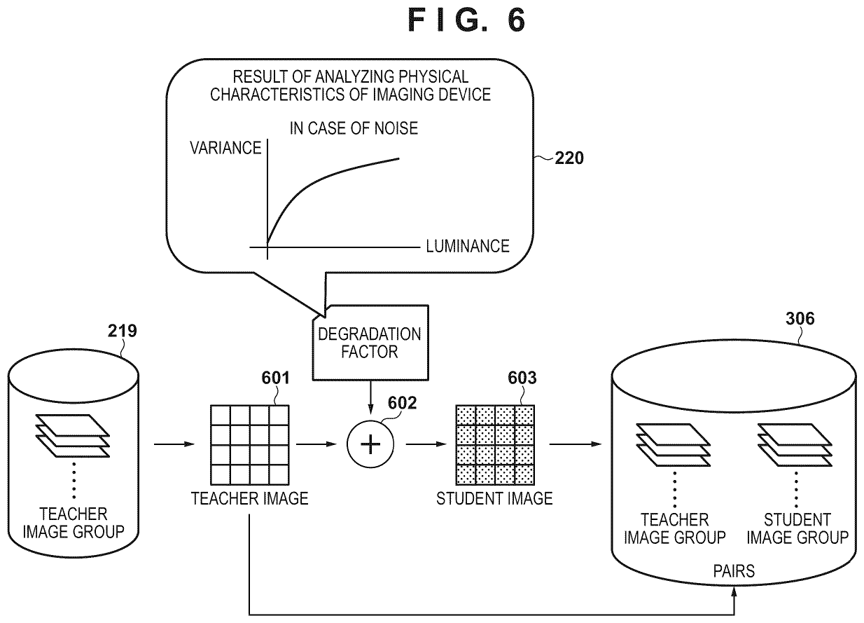

Next, each functional unit of the cloud server 200 will be described. A degradation adding unit 211 generates a student image obtained by adding noise to a teacher image extracted from a teacher image group, which is a collection of images without degradation. In the case of the present embodiment, the degradation adding unit 211 analyzes the physical characteristics of the imaging device 10 and generates a student image by adding, as a degradation factor, noise corresponding to the amount of degradation of a wider range than that of the amount of degradation that may occur in the imaging device 10 to a teacher image. The reason for adding noise corresponding to the amount of degradation in a wider range than that of a result of analysis of the physical characteristics of the imaging device 10 (amount of degradation that may occur in the imaging device 10) is to have a margin since a range of the amount of degradation is different due to individual differences of the imaging device 10 and thus increase robustness. That is, as illustrated in FIG. 6, the degradation adding unit 211 generates a student image 603 by performing an addition 602 of noise that is based on a physical characteristic analysis result 220, which is a result of analyzing the physical characteristics of the imaging device 10, as a degradation factor to a teacher image 601, which has been extracted from a teacher image group 219. Then, the degradation adding unit 211 assumes a pair of the teacher image 601 and the student image 603 as training data. By adding a degradation factor 220 to respective teacher images included in the teacher image group 219, the degradation adding unit 211 generates student images corresponding to the teacher images and generates pairs of a teacher image and a student image as training data. As described above, the degradation adding unit 211 generates a training data group 306, which is a collection of training data (teacher image group and student image group).

Here, the teacher image group 219 includes various types of images, such as nature photography images including scenery and animals, portrait photography images (e.g., portraits and sports photos), and man-made object (e.g., architecture and product) photography images. In the present embodiment, a teacher image is a RAW image in which each pixel has a pixel value corresponding to one of the RGB colors (and thus, a student image similarly is a RAW image in which each pixel has a pixel value corresponding to one of the RGB colors). Further, the physical characteristic analysis result 220 of the imaging device 10 includes the amount of noise for each sensitivity generated in an image sensor incorporated in the camera (imaging device). By using these, it is possible to estimate an extent to which image quality degradation occurs for each imaging condition. That is, by adding degradation estimated for a certain imaging condition to a teacher image, it is possible to generate an image equivalent to an image that would be obtained at the time of imaging.

A developing unit 212 converts each of the teacher images and the student images included in the training data group 306 from a RAW image to an RGB image by performing developing processing on the teacher images and the student images included in the training data group 306 generated by the degradation adding unit 211. In the developing processing, demosaicing processing for interpolating pixels, white balance correction for making white appear white, edge enhancement for increasing contrast, gamma correction for correcting brightness, color correction for increasing vividness, and the like are performed.

A training unit 213 obtains network parameters 221 to be applied to a CNN to be trained to reverse degradation, initializes the weights of the CNN using the obtained network parameters 221, and then performs degradation reversal training using training data generated by the degradation adding unit 211. The network parameters 221 include hyperparameters indicating initial values of the parameters of the CNN, the structure of the CNN, and an optimization method. FIG. 3B is a diagram illustrating a flow of processing in the training unit 213.

An estimation unit 214 obtains the training data group 306 from the degradation adding unit 211 and estimates a noise amount from noise 307 added to a student image 308 included in the training data group 306. Specifically, the estimation unit 214 inputs the student image 308 to the CNN 301 and, by performing computation of the CNN 301 by repeating a convolution operation according to a filter and a nonlinear operation which are expressed by Equations (1) and (2) a plurality of times, outputs a noise amount estimation result 310 which is a result of estimation of the noise amount of the student image 308.

An estimation unit 215 obtains the training data group 306 from the degradation adding unit 211 and estimates a luminance fluctuation amount of the student image 308 included in the training data group 306. Specifically, the estimation unit 215 first inputs the student image 308 to the CNN 303 and, by performing computation of the CNN 303 by repeating a convolution operation according to a filter and a nonlinear operation which are expressed by Equations (1) and (2) a plurality of times, outputs a luminance fluctuation amount estimation result 313 which is a result of estimation of the luminance fluctuation amount of the student image 308.

A restoration unit 216 performs restoration processing on the student image 308. Specifically, the restoration unit 216 first inputs the student image 308, the noise amount estimation result 310, and the luminance fluctuation amount estimation result 313 to the CNN 305 and, by performing computation of the CNN 305 by repeating a convolution operation according to a filter and a nonlinear operation which are expressed by Equations (1) and (2) a plurality of times, outputs a restoration result 316 which is a result of reversing degradation of the student image 308.

An error calculation unit 217 inputs the noise 307 and the noise amount estimation result 310 to loss processing 311, which is computation of a loss function, and calculates an error (first error) between the noise 307 and the noise amount estimation result 310. By inputting the first error calculated by the error calculation unit 217 into update processing 312, a model update unit 218 updates network parameters related to the CNN 301 so as to reduce (minimize) the first error.

Further, the error calculation unit 217 inputs a teacher image 309 and the luminance fluctuation amount estimation result 313 to loss processing 314, which is computation of a loss function, and calculates an error (second error) between the teacher image 309 and the luminance fluctuation amount estimation result 313. By inputting the second error calculated by the error calculation unit 217 into update processing 315, the model update unit 218 updates network parameters related to the CNN 303 so as to reduce the second error.

Further, the error calculation unit 217 inputs the teacher image 309 and the restoration result 316 to loss processing 317, which is computation of a loss function, and calculates an error (third error) between the teacher image 309 and the restoration result 316. By inputting the third error calculated by the error calculation unit 217 into update processing 318, the model update unit 218 updates network parameters related to the CNN 305 so as to reduce the third error.

Here, the noise 307, the student image 308, the noise amount estimation result 310, and the luminance fluctuation amount estimation result 313 are all pixel arrays (images) of the same size having the same number of pixels. Although timings at which an error is calculated are different for each, timings at which network parameters are updated are the same. Further, the CNN 301, the CNN 303, the CNN 305 used in the training unit 213 are the same neural network as the CNN 301, the CNN 303, the CNN 305 used in the inference unit 111, respectively.

The configuration illustrated in FIG. 2 can be modified or changed as appropriate. For example, one functional unit may be divided into a plurality of functional units, or two or more functional units may be integrated into one functional unit. Further, each of the devices illustrated in FIG. 2 may be realized by two or more devices. In this case, the respective devices are connected via a circuit or a wired or wireless network and, by performing cooperative operation by performing data communication with each other, realize each process according to the present embodiment.

### <Flow of Processing of Entire Image Processing System>

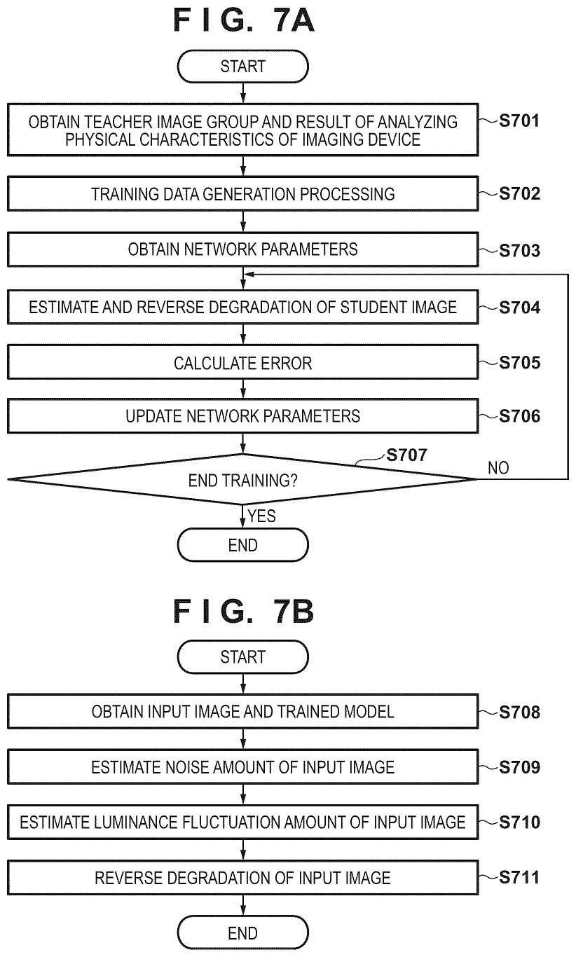

Various kinds of processing to be performed in the image processing system of the present embodiment will be described according to flowcharts of FIGS. 7A and 7B. First, a flow of an example of degradation reversal training to be performed in the cloud server 200 will be described according to a flowchart of FIG. 7A.

In step S701, the degradation adding unit 211 obtains the teacher image group 219 and the physical characteristic analysis result 220, which is a result of analyzing the physical characteristics of the imaging device 10 such as a sensitivity at the time of imaging and the characteristics of the image sensor of the imaging device 10.

A teacher image is a Bayer pattern RAW image and is obtained by performing imaging by the imaging device 10, for example. However, the method of obtaining a teacher image is not limited to a particular obtaining method, and for example, an image captured by the imaging device 10 may be directly uploaded to the cloud server 200, or an image captured in advance may be stored in the HDD or the like and then uploaded to the cloud server 200.

In step S702, the degradation adding unit 211 adds noise that is based on the physical characteristic analysis result 220 to each of the teacher images included in the teacher image group 219 obtained in step S701 and thereby generates student images corresponding to the teacher images. The degradation adding unit 211 adds noise of an amount measured in advance based on the physical characteristic analysis result 220 in preset order or random order. By this, the degradation adding unit 211 generates training data that is pairs of a teacher image and a student image. Then, the developing unit 212 converts the training data that is RAW images into RGB images by performing developing processing on the training data and assumes the RGB images as final training data.

In step S703, the estimation unit 214 and the estimation unit 215 obtain the network parameters 221 to be applied to a CNN to be trained to reverse degradation. The network parameters 221 here include hyperparameters indicating initial values of the parameters of the CNN, the structure of the CNN, and an optimization method as described above.

In step S704, the estimation unit 214 initializes the weights of the CNN 301 using the network parameters 221 and then estimates a noise amount of a student image generated in step S702 using the CNN 301. Further, the estimation unit 215 initializes the weights of the CNN 303 using the network parameters 221 and then estimates a luminance fluctuation amount of the student image generated in step S702 using the CNN 303. Then, the restoration unit 216 inputs the student image, the noise amount estimation result, and the luminance fluctuation amount estimation result into the CNN 305 and, by performing computation of the CNN 305, outputs a result of reversing degradation of the student image.

In step S705, the error calculation unit 217 calculates the first error, the second error, and the third error as described above according to the loss function indicated in Equation (3). In step S706, the update unit 218 updates the respective network parameters of the CNN 301, the CNN 303, and the CNN 305 based on the first error, the second error, and the third error calculated in step S705.

In step S707, the training unit 213 determines whether a condition for ending training has been satisfied. The condition for ending training is not limited to a particular end condition. For example, “the number of updates of the network parameters has reached a prescribed number of times”, “an error is less than a threshold”, “a change in error (difference between a previous error and a current error) is less than a threshold”, or “an elapsed time from the start of training has exceeded a prescribed time” may be assumed as the condition for ending training. In addition, two or more such conditions may be combined to constitute the condition for ending training.

As a result of such determination, if it is determined that the condition for ending training is satisfied, the processing according to the flowchart of FIG. 7A ends, and if it is determined that the condition for ending training is not satisfied, the processing proceeds to step S704.

Next, an example of degradation reversal inference to be performed in the edge device 100 will be described according to a flowchart of FIG. 7B. In step S708, the inference unit 111 obtains the trained model 222 generated by the cloud server 200 and the input image 115 to be a target of degradation reversal processing. Regarding the input image 115, what has been captured by the imaging device 10 may be inputted directly or what has been captured in advance and stored in the large-capacity storage device 104 may be read out, for example.

In step S709, the estimation unit 112 estimates the noise amount of the input image 115 using the CNN 301 included in the trained model 222 generated by the training unit 213. As described above, the estimation unit 112 inputs the input image 115 to the CNN 301 to which the updated network parameters have been applied by the training unit 213 and estimates the noise amount using the same method as that of the training unit 213.

In step S710, the estimation unit 113 estimates the luminance fluctuation amount of the input image 115 using the CNN 303 included in the trained model 222 generated by the training unit 213. As described above, the estimation unit 113 inputs the input image 115 to the CNN 303 to which network parameters updated by the training unit 213 have been applied and estimates the luminance fluctuation amount using the same method as that of the training unit 213.

In step S711, the restoration unit 114 inputs the input image 115, the noise amount estimated in step S709, and the luminance fluctuation amount estimated in step S710 to the CNN 305 included in the trained model 222 generated by the training unit 213. Then, the restoration unit 114 reverses degradation of the input image 115 by performing computation of the CNN 305 and outputs the output image 116, which has been subjected to the restoration processing. As described above, the restoration unit 114 performs degradation reversal using the CNN 305 to which network parameters updated by the training unit 213 have been applied, using the same method as that of the training unit 213.

In the present embodiment, a method in which a noise amount of an input image and the amount of fluctuation in luminance generated due to noise are independently estimated, and degradation of the input image is reversed based on respective estimation results has been described.

Up until now, measures for preventing occurrence of a magenta cast have been often taken, and although noise could be reduced in an image in which a magenta cast has occurred, the magenta cast could not be suppressed.

Meanwhile, as in the present embodiment, by estimating a noise amount and a luminance fluctuation amount of an input image using a CNN and reversing degradation of the input image based on respective estimation results, it is possible to achieve both magenta cast suppression and noise reduction.

In the present embodiment, training data is generated in step S702 but may be generated in a subsequent step. Specifically, a configuration may be taken so as to generate a student image corresponding to a teacher image during subsequent degradation reversal training.

In the present embodiment, training is performed from untrained network parameters using a teacher image group prepared in advance. However, the processing of the present embodiment may be performed based on trained network parameters.

In the present embodiment, it has been described that a RAW image captured using a Bayer pattern color filter is used at the time of training, but it may be a RAW image captured using a color filter of another color filter pattern.

In the present embodiment, an example in which the inference unit 111 outputs only the output image 116 which is the input image 115 that has been subjected to the restoration processing has been described, but the present invention is not limited thereto, and for example, estimation results outputted by the estimation units 112 and 113 may be outputted together with the output image 116.

In the present embodiment, although an output destination of the output image 116 is not mentioned, the output destination of the output image 116 is not limited to a specific output destination. For example, the edge device 100 may display the output image 116 on the display device 40, store the output image 116 in a memory device such as the large-capacity storage device 104, or transmit the output image 116 to another device such as the cloud server 200 via the network I/F 106.

In the present embodiment, an example in which restoration is performed from an input image using a trained model on the edge device 100 side has been described, but a parameter for assisting degradation reversal may be used. For example, the edge device 100 holds a look-up table obtained by estimating in advance what extent of degradation of image quality occurs according to imaging conditions such as exposure and the size of the imaging sensor of the imaging device 10. Then, the edge device 100 may adjust a restoration amount (intensity at which degradation is reversed) by referring to the look-up table at the time of reversing degradation. That is, the inference unit 111 of the edge device 100 obtains, from the look-up table, a restoration amount corresponding to an imaging condition for when the input image was captured. For example, the inference unit 111 may reduce the pixel value of a pixel of a dark portion that is higher than a black reference value according to the restoration amount or increase the pixel value of a pixel of a bright portion that is lower than a bit depth maximum value according to the restoration amount. In the present embodiment, the order of estimation of the noise amount of the input image and estimation of the luminance fluctuation amount of the input image is in no particular order, and it is sufficient that both estimated values are calculated when reversing degradation.

In the present embodiment, suppression of a magenta cast has been described using an RGB image as an example, but it is also possible to suppress fading of a black color occurring in a RAW image. In this case, the developing unit 212 and the developing processing of step S702 become unnecessary, and subsequent processing is executed with the RAW image as is.

### Second Embodiment

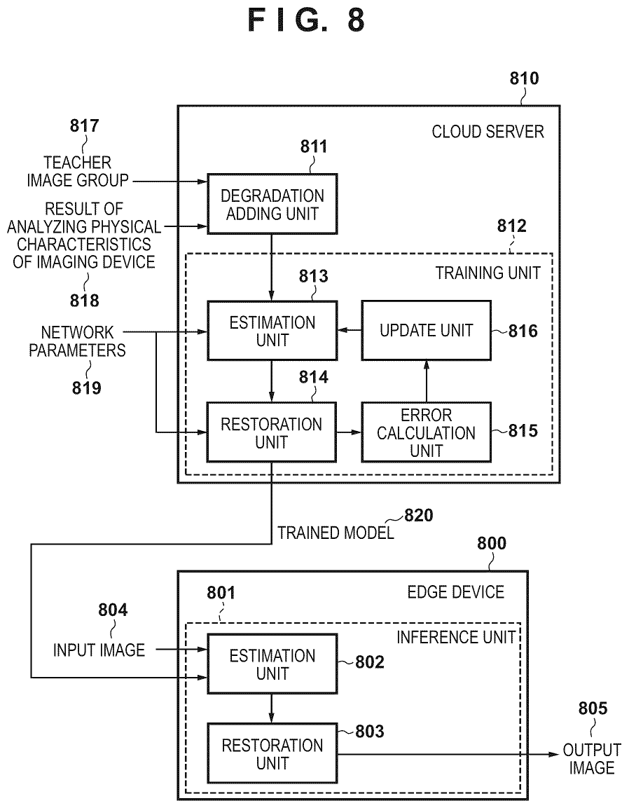

In each of the following embodiments including the present embodiment, differences from the first embodiment will be described, and unless otherwise mentioned below, it is assumed that it is similar to the first embodiment. In the first embodiment, an example in which a noise amount and a luminance fluctuation amount of an input image are independently estimated and degradation of the input image is reversed using results of the estimation has been described. In contrast to this, in the present embodiment, an example in which a noise amount and a luminance fluctuation amount of an input image are simultaneously estimated and degradation of the input image is reversed using a result of the estimation will be described. In the present embodiment, an example in which degradation estimation and degradation reversal are performed on a RAW image will be described. An example of a functional configuration of an image processing system according to the present embodiment will be described with reference to a block diagram of FIG. 8. First, each functional unit of an edge device 800 will be described.

An estimation unit 802 obtains an input image 804 and, using a trained model 820, estimates a degradation amount representing an extent of degradation of the input image 804. Here, in the present embodiment, a Bayer pattern RAW image is used as the input image 804. The degradation amount to be estimated is a noise amount and a luminance fluctuation amount of the input image 804, and a CNN is used to estimate the degradation amount. The estimation unit 802 inputs the input image 804 to the CNN and, by performing computation of the CNN 305 by repeating a convolution operation according to a filter and a nonlinear operation which are expressed by Equations (1) and (2) a plurality of times, outputs a degradation estimation result which is a result of estimating image degradation of the input image 804.

A restoration unit 803 performs processing for reversing degradation of the input image 804 based on the degradation estimation result outputted by the estimation unit 802. A CNN is used for the processing for reversing degradation of the input image 804. The restoration unit 803 concatenates the degradation estimation result outputted by the estimation unit 802 and the input image 804 and inputs that to the CNN and, by performing computation of the CNN by repeating a convolution operation according to a filter and a nonlinear operation which are expressed by Equations (1) and (2) a plurality of times, outputs an output image 805 obtained by reversing degradation of the input image 804.

Next, each functional unit of a cloud server 810 will be described. A degradation adding unit 811 performs similar processing as the degradation adding unit 211 described above. A training unit 812 obtains network parameters 819 to be applied to a CNN to be trained to reverse degradation, initializes the weights of the CNN using the network parameters 819, and then performs degradation reversal training using a training data group generated by the degradation adding unit 811.

An estimation unit 813 estimates the amount of degradation included in a student image included in the training data obtained from the degradation adding unit 811 and outputs a degradation estimation result. A restoration unit 814 performs processing for reversing degradation of the student image based on the student image and the degradation estimation result estimated by the estimation unit 813. An error calculation unit 815 includes the same functions as the error calculation unit 217, and an update unit 816 includes the same functions as the update unit 218. As described above, a difference between the second embodiment and the first embodiment is in that degradations (noise amount and luminance fluctuation amount) to be estimated are simultaneously estimated.

### <Flow of Processing of Entire Image Processing System>

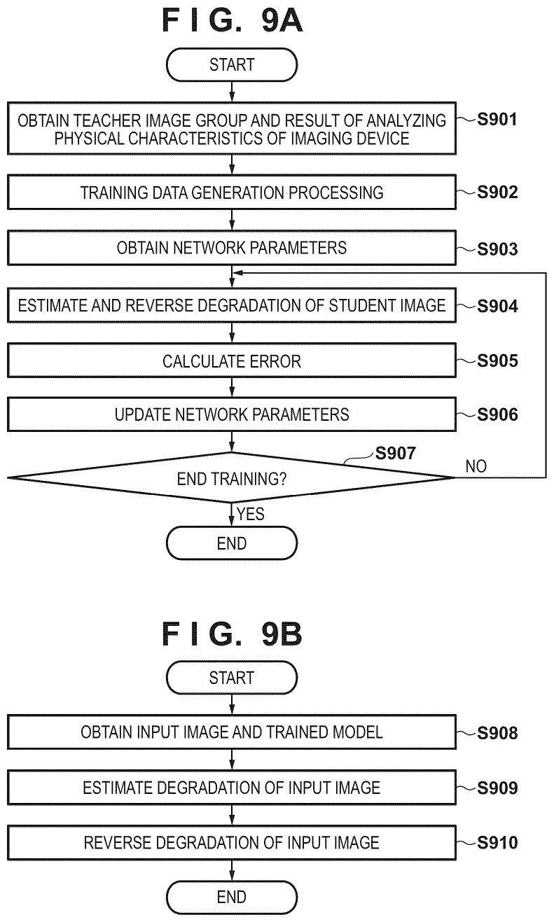

Next, various kinds of processing to be performed in the image processing system according to the present embodiment will be described according to flowcharts of FIGS. 9A and 9B. First, a flow of an example of degradation reversal training to be performed in the cloud server 810 will be described according to a flowchart of FIG. 9A.

In step S901, the degradation adding unit 811 obtains a teacher image group 817 and a physical characteristic analysis result 818, which is a result of analyzing the physical characteristics of the imaging device 10 such as the sensitivity at the time of imaging and the characteristics of the image sensor of the imaging device 10.

In step S902, similarly to step S702, the degradation adding unit 811 adds noise that is based on the physical characteristic analysis result 818 to each of the teacher images included in the teacher image group 817 obtained in step S901 and thereby generates student images corresponding to the teacher images. By this, the degradation adding unit 811 generates training data that is pairs of a teacher image and a student image.

In step S903, similarly to the above step S703, the estimation unit 813 obtains the network parameters 819 to be applied to a CNN to be trained to reverse degradation. In step S904, similarly to the above step S704, the estimation unit 813 initializes the weights of the CNN for estimating a degradation amount using the network parameters 819. Then, the estimation unit 813 estimates a noise amount and a luminance fluctuation amount of a student image generated in step S902 as a degradation amount (degradation estimation result) of a student image using the CNN. Then, similarly to the above step S704, the restoration unit 814 performs processing for reversing degradation of the student image based on the student image generated in step S902 and the degradation estimation result estimated by the estimation unit 813.

In step S905, the error calculation unit 815 calculates an error between a result of processing for reversing degradation by the restoration unit 814 and a teacher image according to the loss function indicated in Equation (3). In step S906, the update unit 816 updates the network parameters of the CNN used in step S904 based on the error calculated in step S905.

In step S907, the training unit 812 determines whether a condition for ending training has been satisfied. As a result of such determination, if it is determined that the condition for ending training is satisfied, the processing according to the flowchart of FIG. 9A ends, and if it is determined that the condition for ending training is not satisfied, the processing proceeds to step S904.

Next, an example of degradation reversal inference to be performed in the edge device 800 will be described according to a flowchart of FIG. 9B. In step S908, an inference unit 801 obtains the trained model 820 (CNN to which network parameters updated by the training unit 812 are applied) generated by the cloud server 810 and the input image 804 to be a target of degradation reversal processing.

In step S909, the estimation unit 802 estimates a degradation amount (noise amount and luminance fluctuation amount) of the input image 804 using the trained model 820 generated by the training unit 812.

In step S910, the restoration unit 803 inputs the input image 804 and the noise amount and the luminance fluctuation amount estimated in step S909 to the trained model 820. Then, the restoration unit 803 reverses degradation of the input image 804 by performing computation of the trained model 820 and outputs the output image 805, which has been subjected to the restoration processing.

As described above, in the present embodiment, an example in which a CNN for estimating a noise amount and a luminance fluctuation amount of an input image is obtained by training, the noise amount and the luminance fluctuation amount of the input image are simultaneously estimated using the CNN, and degradation of the input image is reversed using a result of the estimation has been described.

By this, even in an input image in which a magenta cast has occurred, a noise amount and a luminance fluctuation amount of the input image are simultaneously estimated and, based on an estimation result, it is possible to achieve both magenta cast suppression and noise reduction. As described above, in the present embodiment, a noise amount and a luminance fluctuation amount are simultaneously estimated, and so, it is possible to simplify processing compared to the first embodiment.

### Third Embodiment

In the first and second embodiments, an example in which degradation of an input image is reversed based on a result of estimating a noise amount and a luminance fluctuation amount of the input image has been described. This achieves both magenta cast suppression and noise reduction for an input image in which a magenta cast and darkening of a white color has occurred and outputs an image in which degradation has been reversed.

In the present embodiment, an example in which it is determined whether fading of a black color, a magenta cast, or darkening of a white color has occurred based on an estimated noise amount and luminance fluctuation amount, and if at least one has occurred, a switch is made to low-sensitivity imaging and other processing is performed, and thereby, an image in which a magenta cast has been suppressed is outputted will be described. In the present embodiment, as the other processing, an example in which an image in which a magenta cast or the like is suppressed is outputted by performing noise reduction on a low-sensitivity image in which a magenta cast or the like does not occur and applying a digital gain thereto so as to restore a pre-switch sensitivity will be described.

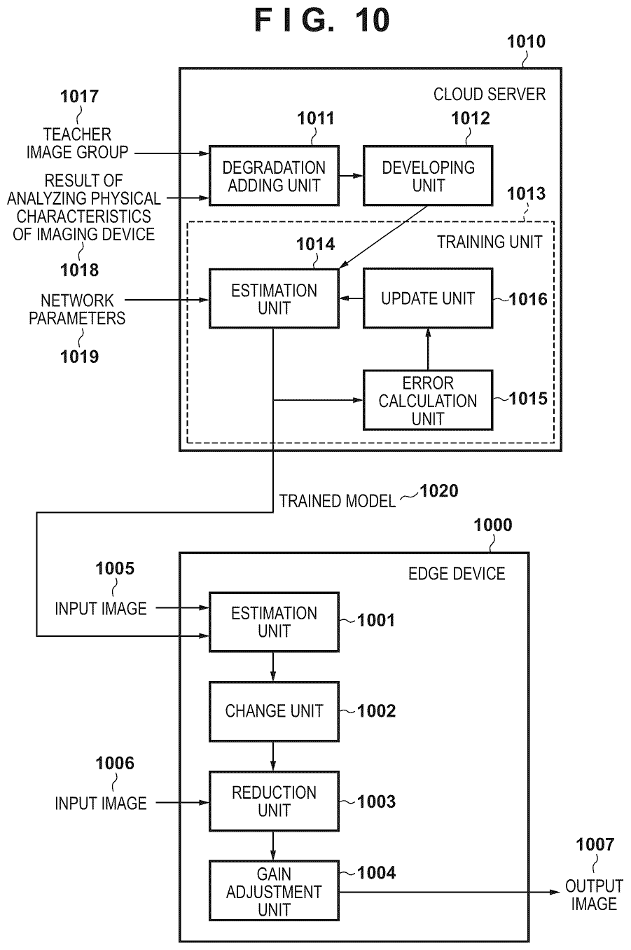

An example of a functional configuration of an image processing system according to the present embodiment will be described with reference to a block diagram of FIG. 10. First, each functional unit of an edge device 1000 will be described. An estimation unit 1001 obtains an input image 1005 and estimates a degradation amount representing an extent of degradation of the input image 1005 using a trained model 1019 provided by the cloud server 200, similarly to the estimation unit 802. Here, in the present embodiment, an RGB image is used as the input image 1005.

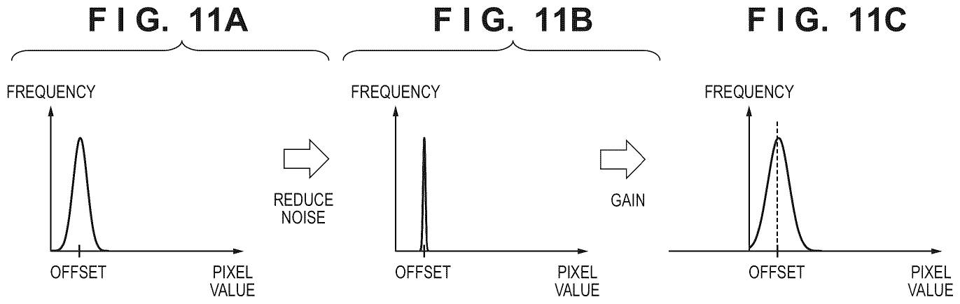

A change unit 1002 determines whether fading of a black color, a magenta cast, or darkening of a white color has occurred based on a result of degradation estimation by the estimation unit 1001 and, if at least one has occurred, changes an imaging condition of the imaging device 10 so as to reduce exposure. As an estimate, the sensitivity is reduced to that at which a digital gain begins to be applied. This makes it possible to capture an image in which fading of a black color, darkening of a white color, or a magenta cast has not occurred (e.g., image of a pixel value distribution illustrated in FIG. 11A).

In general, there are two types of gain of an imaging device at the time of high-sensitivity imaging: an analog gain and a digital gain. The former amplifies electric charge in a process in which light to which an image sensor has been exposed is converted into electric charge, and the latter amplifies a pixel value by software computation after A/D conversion, and a digital gain is applied after an analog gain is applied.

A reduction unit 1003 obtains an input image 1006, which is an image (subsequent RGB image) subsequent to the input image 1005, and reduces the noise amount of the input image 1006. The input image 1006 may be an image of a subsequent frame adjacent to the input image 1005 or may be an image of a subsequent frame separated from the input image 1005 by one or more frames.

Any method may be used as a method of reducing a noise amount of an image, and for example, a trained model that has learned processing for reducing noise of a low-sensitivity image may be used, or an edge preserving filter such as a simple average filter or a bilateral filter may be used. FIG. 11B illustrates a distribution of pixel values in an image, which is a result of performing noise reduction on an image of a pixel value distribution of FIG. 11A.

A gain adjustment unit 1004 generates an output image 1007 obtained by applying a gain to an image in which the noise amount has been reduced by the reduction unit 1003 such that the exposure is the same as that of the input image 1005 and outputs the output image 1007.

FIG. 11C illustrates a distribution of pixel values of an image obtained by applying a gain to an image with the distribution of pixel values of FIG. 11B. By reducing noise before the gain is applied, it is possible to suppress fading of a black color and a magenta cast even if the gain is applied so as to restore the original brightness.

Next, each functional unit of a cloud server 1010 will be described. A degradation adding unit 1011 obtains a teacher image group 1017 and a physical characteristic analysis result 1018, which is a result of analyzing the physical characteristics of the imaging device 10, and generates a training data group by performing similar processing as the degradation adding unit 211 and the developing unit 212.

A training unit 1013 obtains network parameters 1019, initializes the weights of a CNN using the obtained network parameters 1019, and then performs training for estimating degradation using the training data generated by the degradation adding unit 1011 and a developing unit 1012. An estimation unit 1014, an error calculation unit 1015, and an update unit 1016 perform similar operations as the estimation unit 813, the error calculation unit 815, and the update unit 816, respectively.

### <Flow of Processing of Entire Image Processing System>

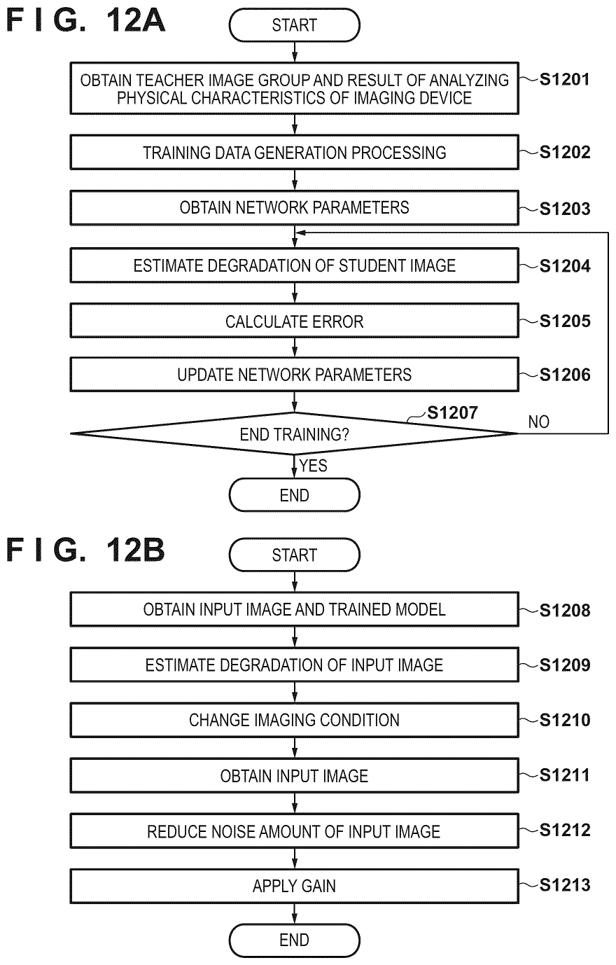

Various kinds of processing to be performed in the image processing system of the present embodiment will be described according to flowcharts of FIGS. 12A and 12B. First, a flow of an example of degradation reversal training to be performed in the cloud server 1010 will be described according to a flowchart of FIG. 12A.

In step S1201, the degradation adding unit 1011 obtains the teacher image group 1017 and the physical characteristic analysis result 1018, which is a result of analyzing the physical characteristics of the imaging device 10 such as the sensitivity at the time of imaging and the characteristics of the image sensor of the imaging device 10.

In step S1202, similarly to the above step S702, the degradation adding unit 1011 adds noise that is based on physical characteristic analysis result 1018 to each of the teacher images included in the teacher image group 1017 obtained in step S1201 and thereby generates student images corresponding to the teacher images. By this, the degradation adding unit 1011 generates training data that is pairs of a teacher image and a student image. Then, the developing unit 1012 converts the training data that is RAW images into RGB images by performing developing processing on the training data and assumes the RGB images as final training data.

In step S1203, similarly to the above step S703, the training unit 1013 obtains the network parameters 1019 to be applied to a CNN to be trained to reverse degradation. In step S1204, the estimation unit 1014 initializes the weights of the CNN for estimating a degradation amount using the network parameters 1019 and then estimates a noise amount and a luminance fluctuation amount of a student image generated in step S1202 as a degradation amount (degradation estimation result) of the student image.

In step S1205, the error calculation unit 1015 calculates an error between a result of degradation estimation by the estimation unit 1014 and a teacher image according to the loss function indicated in Equation (3). In step S1206, the update unit 1016 updates the network parameters of the CNN used in step S1204 based on the error calculated in step S1205.

In step S1207, the training unit 1013 determines whether a condition for ending training has been satisfied. As a result of such determination, if it is determined that the condition for ending training is satisfied, the processing according to the flowchart of FIG. 12A ends, and if it is determined that the condition for ending training is not satisfied, the processing proceeds to step S1204.

Next, an example of degradation reversal inference to be performed in the edge device 1000 will be described according to a flowchart of FIG. 12B. In step S1208, an inference unit 1001 obtains the trained model 1019 (CNN to which network parameters updated by the training unit 1013 are applied) generated by the cloud server 1010 and the input image 1005 to be a target of degradation reversal processing.

In step S1209, the inference unit 1001 estimates a degradation amount (noise amount and luminance fluctuation amount) of the input image 1005 using the trained model 1019. In step S1210, the change unit 1002 determines whether fading of a black color, a magenta cast, or darkening of a white color has occurred based on a result of degradation estimation by the estimation unit 1001 and, if at least one has occurred, changes an imaging condition of the imaging device 10 so as to reduce exposure.

In step S1211, the reduction unit 1003 obtains the input image 1006. In step S1212, the reduction unit 1003 reduces the noise amount of the input image 1006 obtained in step S1211.

In step S1213, the gain adjustment unit 1004 generates the output image 1007 obtained by applying a gain to the input image 1006 in which the noise amount has been reduced in step S1212 such that the exposure becomes the same as that of the input image 1005 and outputs the output image 1007.

In the present embodiment, an example in which it is determined whether fading of a black color, a magenta cast, or darkening of a white color has occurred based on an estimated noise amount and luminance fluctuation amount, and if at least one has occurred, a switch is made to low-sensitivity imaging and a gain is applied after noise reduction to restore the original brightness has been described.

For example, when capturing a moving image with high sensitivity such as ISO 102400, if a magenta cast occurs, the sensitivity is changed to low sensitivity such as ISO 1600, and a gain (six stops' worth) is applied to a result obtained by reducing noise in a low-sensitivity image so as to achieve the original brightness.

By this, difficulty of processing is reduced in reversing degradation without causing a magenta cast in the first place than in reversing degradation of an image in which a magenta cast has already occurred, and so, it is possible to obtain a degradation reversal result with better accuracy. Therefore, although it may be cumbersome in that it is necessary to switch an imaging condition, the technique is effective when obtaining a better degradation reversal result.

In the present embodiment, an example in which, when a magenta cast has occurred, a gain is applied to a result of switching to low-sensitivity imaging and performing noise reduction has been described, but the present invention is not limited thereto. For example, processing may be performed using a neural network that simultaneously performs noise reduction and gain application.

In the present embodiment, suppression of a magenta cast has been described using an RGB image as an example, but it is also possible to suppress fading of a black color occurring in a RAW image. In this case, the developing unit 1012 and the developing processing of step S1202 become unnecessary, and subsequent processing is executed with the RAW image as is.

The configurations of the devices described in each of the above embodiments may be appropriately modified or changed depending on various conditions (e.g., usage conditions and usage environments of the devices) and specifications of the devices to be actually applied as the device.

The numerical values, processing timing, processing order, processing entity, color space, data (information) obtainment method/transmission destination/transmission source/storage location, and the like used in each of the embodiments described above have been given as examples for the sake of providing a concrete explanation, and the present invention is not intended to be limited to such examples.

Further, some or all of the embodiments described above may be appropriately combined and used. Further, some or all of the embodiments described above may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
an estimation unit configured to estimate a noise amount of an input image and a fluctuation amount of luminance of the input image caused by noise or developing; and
a restoration unit configured to reverse degradation of the input image based on the noise amount and the fluctuation amount.

2. The image processing apparatus according to claim 1, wherein the estimation unit estimates the noise amount using a trained CNN for estimating the noise amount.

3. The image processing apparatus according to claim 1, wherein the estimation unit estimates the fluctuation amount using a trained CNN for estimating the fluctuation amount.

4. The image processing apparatus according to claim 1, wherein the estimation unit estimates the noise amount and the fluctuation amount using a trained CNN for estimating the noise amount and the fluctuation amount.

5. The image processing apparatus according to claim 1, wherein the noise amount and the fluctuation amount are in a proportional relationship, and the estimation unit estimates a fluctuation amount of luminance caused by processing for fitting the noise amount within a range of unsigned integers that can be stored at a predetermined bit depth.

6. The image processing apparatus according to claim 1, wherein the estimation unit estimates a fluctuation amount of luminance caused by fading of a black color, darkening of a white color, and a magenta cast.

7. An image processing apparatus comprising:
an estimation unit configured to estimate a noise amount of an input image captured by an imaging device and a fluctuation amount of luminance of the input image caused by noise or developing; and
a control unit configured to control exposure of the imaging device based on the noise amount and the fluctuation amount.

8. The image processing apparatus according to claim 7, wherein the control unit determines whether fading of a black color, a magenta cast, or darkening of a white color has occurred based on the noise amount and the fluctuation amount and, in a case where at least one has occurred, changes an imaging condition of the imaging device so as to reduce exposure.

9. The image processing apparatus according to claim 7, further comprising a unit configured to reduce a noise amount of an image that is subsequent to the input image and then generate and output, as an output image, an image to which a gain has been applied such that exposure is the same as that of the input image.

10. An image processing method to be performed by an image processing apparatus, the method comprising:
estimating a noise amount of an input image and a fluctuation amount of luminance of the input image caused by noise or developing; and
reversing degradation of the input image based on the noise amount and the fluctuation amount.

11. An image processing method to be performed by an image processing apparatus, the method comprising:
estimating a noise amount of an input image captured by an imaging device and a fluctuation amount of luminance of the input image caused by noise or developing; and
controlling exposure of the imaging device based on the noise amount and the fluctuation amount.

12. A non-transitory computer-readable storage medium storing a computer program for causing a computer to function as:
an estimation unit configured to estimate a noise amount of an input image and a fluctuation amount of luminance of the input image caused by noise or developing; and
a restoration unit configured to reverse degradation of the input image based on the noise amount and the fluctuation amount.

13. A non-transitory computer-readable storage medium storing a computer program for causing a computer to function as:
an estimation unit configured to estimate a noise amount of an input image captured by an imaging device and a fluctuation amount of luminance of the input image caused by noise or developing; and
a control unit configured to control exposure of the imaging device based on the noise amount and the fluctuation amount.
